(19) United States
(12) Patent Application Publication
(10) Pub. No.: US 2024/0397013 A1
(43) Pub. Date: Nov. 28, 2024

(54) INFORMATION PROCESSING SYSTEM, NON-TRANSITORY COMPUTER READABLE MEDIUM STORING PROGRAM, AND INFORMATION PROCESSING METHOD

(71) Applicant: FUJIFILM Business Innovation Corp., Tokyo (JP)

(72) Inventor: Misaki MATSUZAWA, Kanagawa (JP)

(73) Assignee: FUJIFILM Business Innovation Corp., Tokyo (JP)

(21) Appl. No.: 18/500,134

(22) Filed: Nov. 2, 2023

(30) Foreign Application Priority Data
May 24, 2023 (JP) 2023-085308

(51) Int. Cl. H04N 1/44

(52) U.S. Cl. CPC H04N 1/444; H04N 2201/0094

(57) ABSTRACT

An information processing system includes a processor configured to: extract document-specifying information and user identification information from scanned data of a printed document obtained from printing of document data of a document, the document-specifying information and the user identification information being added to the printed document, the document-specifying information specifying the document, and the user identification information identifying a user allowed to use the document; extract use authority information about the document that is set in the document data of the document specified by the extracted document-specifying information and is given to the user identification information identifying the user allowed to use the document and the user; and determine handling of the scanned data depending on the extracted use authority information.

### CROSS-REFERENCE TO RELATED APPLICATIONS

This application is based on and claims priority under 35 USC 119 from Japanese Patent Application No. 2023-085308 filed May 24, 2023.

### BACKGROUND

### (i) Technical Field

The present invention relates to an information processing system, a non-transitory computer readable medium storing a program, and an information processing method.

### (ii) Related Art

It is general that document data are saved in a storage unit, are read out from the storage unit as necessary, and are printed and used. Scanned data generated from the scanning of printed matter originally match the original document data, but a case where the printed matter is tampered or the like is also conceivable.

Accordingly, for example, in JP2008-306650A, address information indicating a location at which document data are stored is added to the document data and then saved in a server. In a case where an approver receives printed matter to which address information is added in a state where the address information cannot be visually recognized, the approver scans the printed matter with a scanner. Address information is extracted from scanned data of the printed matter obtained in this way, document data specified by the extracted address information are acquired from the server, and whether or not the contents of the acquired document data match the contents of the scanned data is determined.

Further, in JP2008-306650A, the scanned data can be saved in a case where the approver approves even though the scanned data do not match the document data.

### SUMMARY

However, in the related art, the scanned data are always saved as a separate document in a case where the scanned data do not match the document data. That is, since the use authority of a user set in the document data is not referred in the related art, the scanned data are always saved as a separate document against the user's intent even though, for example, a user wants to update updatable document data with the scanned data.

Aspects of non-limiting embodiments of the present disclosure relate to an information processing system, a non-transitory computer readable medium storing a program, and an information processing method that allow a user to handle scanned data of a document as intended as compared to a case where the use authority of a user for document data is not referred.

Aspects of certain non-limiting embodiments of the present disclosure overcome the above disadvantages and/or other disadvantages not described above. However, aspects of the non-limiting embodiments are not required to overcome the disadvantages described above, and aspects of the non-limiting embodiments of the present disclosure may not overcome any of the disadvantages described above.

According to an aspect of the present disclosure, there is provided an information processing system including a processor configured to: extract document-specifying information and user identification information from scanned data of a printed document obtained from printing of document data of a document, the document-specifying information and the user identification information being added to the printed document, the document-specifying information specifying the document, and the user identification information identifying a user allowed to use the document; extract use authority information about the document that is set in the document data of the document specified by the extracted document-specifying information and is given to the user identification information identifying the user allowed to use the document and the user; and determine handling of the scanned data depending on the extracted use authority information.

### BRIEF DESCRIPTION OF THE DRAWINGS

Exemplary embodiment(s) of the present invention will be described in detail based on the following figures, wherein:

FIG. 1 is an overall schematic diagram of an information processing system according to a first exemplary embodiment;

FIG. 2 is a block diagram showing the information processing system according to the first exemplary embodiment;

FIG. 3 is a diagram showing an example of a data configuration of document information that is added to document data handled in the first exemplary embodiment;

FIG. 4 is a flowchart showing processing in a cloud that handles scanned data in the first exemplary embodiment;

FIG. 5 is a flowchart showing save determination processing of the first exemplary embodiment;

FIG. 6 is a block diagram showing an information processing system according to a second exemplary embodiment;

FIG. 7 is a diagram showing an example of a data configuration of document information that is added to document data handled in the second exemplary embodiment; and

FIG. 8 is a flowchart showing processing in a cloud that handles scanned data in the second exemplary embodiment.

### DETAILED DESCRIPTION

Exemplary embodiments of the present invention will be described below with reference to the drawings.

### First Exemplary Embodiment

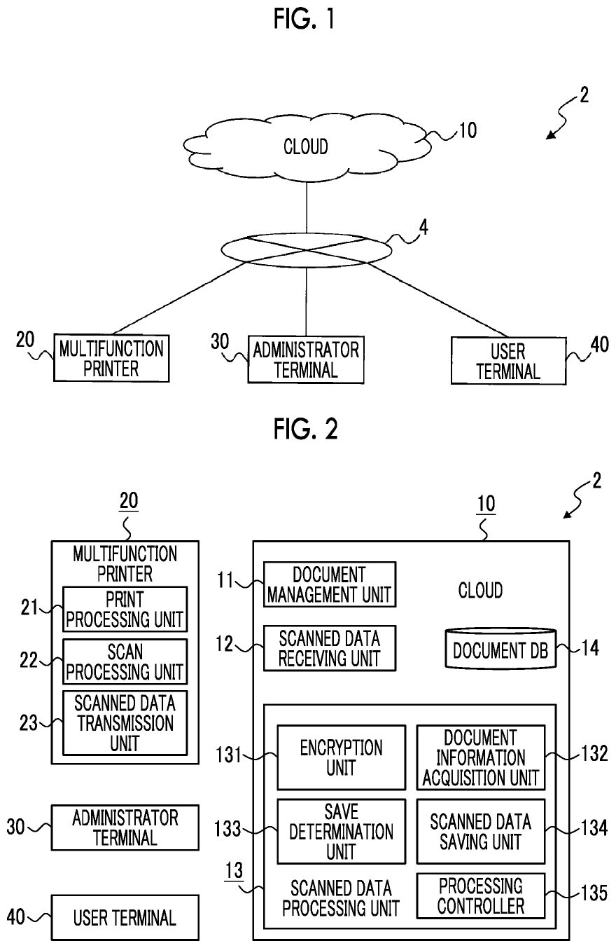

FIG. 1 is an overall schematic diagram of an information processing system according to an exemplary embodiment of the present invention. FIG. 1 shows a cloud 10 and a multifunction printer 20, an administrator terminal 30, and a user terminal 40 that are connected to the cloud 10 via a network 4, such as Internet. The cloud 10 of the present exemplary embodiment provides a service that holds and manages document data via the network 4.

The multifunction printer 20 is an aspect of an image forming apparatus on which various functions, such as a print function, a copy function, and a scanner function, are mounted and is an apparatus in which a computer is built. That is, the multifunction printer 20 includes a CPU, a ROM, a RAM, a hard disk drive (HDD) as a storage unit, a network interface (IF) provided as a communication unit, and a user interface, such as an operation panel. Further, the multifunction printer 20 includes devices, such as a scanner and a printer, to provide various functions to a user. The multifunction printer 20 of the present exemplary embodiment may be realized by a hardware configuration that has existed in the past.

The administrator terminal 30 is a terminal device used by an administrator, the user terminal 40 is a terminal device used by a user who uses a document, and each of both the administrator terminal 30 and the user terminal 40 can be realized by a general-purpose hardware configuration that has existed in the past, such as a personal computer (PC). That is, each of the terminals 30 and 40 includes a CPU, a ROM, a RAM, a hard disk drive (HDD) as a storage unit, a network interface (IF) provided as a communication unit, and an input unit, such as a mouse or a keyboard, and a display unit, such as a display, or a user interface, such as a touch panel.

An administrator who uses the administrator terminal 30 is an administrator of various documents to be managed in the cloud 10. The various documents are usually created by a user who uses the user terminal 40. Since each of the multifunction printer 20, the administrator terminal 30, and the user terminal 40 may have equivalent functions, one multifunction printer 20, one administrator terminal 30, and one user terminal 40 are shown in FIG. 1 but a plurality of multifunction printers 20, administrator terminals 30, and user terminals 40 may be connected to the network 4. The multifunction printer 20 is basically installed in a certain on-premises environment. Since the administrator and the user work in the on-premises environment, it is assumed that the administrator terminal 30 and the user terminal 40 are installed in an identical on-premises environment as the multifunction printer 20. However, as long as being capable of communicating with each other via the network 4, the administrator terminal 30 and the user terminal 40 may not necessarily be installed in the on-premises environment.

FIG. 2 is a block diagram showing the information processing system 2 according to the present exemplary embodiment. Components not used in the description of the present exemplary embodiment will be omitted in FIG. 2.

The cloud 10 includes a document management unit 11, a scanned data receiving unit 12, a scanned data processing unit 13, and a document database (DB) 14.

The document management unit 11 manages the registration, editing, deletion, and the like of document data in the document database 14. The scanned data receiving unit 12 receives scanned data that are transmitted from the multifunction printer 20. The scanned data processing unit 13 performs processing related to the scanned data that are received by the scanned data receiving unit 12. Specifically, as described in detail later, the scanned data processing unit 13 determines handling, such as what saving form the scanned data should be saved in or whether or not to save the scanned data.

The scanned data processing unit 13 includes an encryption unit 131, a document information acquisition unit 132, a save determination unit 133, a scanned data saving unit 134, and a processing controller 135. The encryption unit 131 encrypts and decrypts the scanned data. The document information acquisition unit 132 acquires document information that is set in the document data of a document specified from address information extracted from the scanned data. The save determination unit 133 determines whether or not to save the scanned data, and determines a saving form in a case where the scanned data are to be saved. The scanned data saving unit 134 saves the scanned data in the determined saving form in a case where the scanned data saving unit 134 is to save the scanned data. The processing controller 135 operates in cooperation with the components 131 to 134 to control processing on the scanned data.

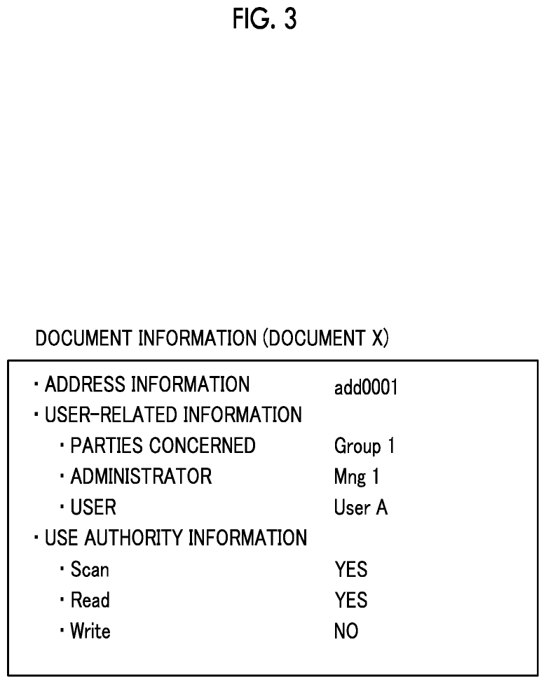

The document data, which are held and managed by the cloud 10, are accumulated in the document database 14. FIG. 3 is a diagram showing an example of a data configuration of document information that is added to the document data handled in the present exemplary embodiment. As shown in FIG. 3, the document information includes address information, user-related information, and use authority information. FIG. 3 also shows a setting example for each data item, specifically, a setting example of document information set for a document X together. Various types of attribute information, such as a creation date and a document type, are added to the document, but only the data items to be used in the description of the present exemplary embodiment are shown in FIG. 3. A document may be digitized to a form of printed matter to take a form of data (hereinafter, referred to as “document data”), but document information is added to the document data of the document and is held and managed in a document database 14. In the present exemplary embodiment, for the convenience of description, “document” and “document data” may be used without being distinguished from each other.

The address information is an example of document-specifying information that specifies the document, and specifies a location at which the document data are stored in the document database 14. Information, which can identify the document, such as document ID, may be used as the document-specifying information.

The user-related information includes information about a user related to the document. The user-related information of the present exemplary embodiment includes parties concerned, an administrator, and a user. A user related to the document is designated as the parties concerned. For example, in a case where the document is a document related to a certain project, a project member corresponds to the parties concerned. The parties concerned correspond to so-called group information. Identification information of an administrator (hereinafter, referred to as “administrator ID”) of the document is set for the administrator. For example, since a status, such as a creator or a possessor of the document, is granted to the user, the identification information of a user who can use the document (hereinafter, referred to as “user ID”) is set for the user. A case where only one person among the parties concerned is set as the user will be described in the present exemplary embodiment by way of example. FIG. 3 shows an example in which identification codes, such as “GrpG”, “Mng1”, and “UserA”, are set to the parties concerned, the administrator, and the user as item data, respectively.

The use authority of the document set for the user (the “UserA”) is set as the use authority information. A case where use authority, such as scanning authority (Scan), readout authority (Read), and writing authority (Write), is set will be described in the present exemplary embodiment by way of example, but the present invention does not need to be limited thereto. FIG. 3 shows an example in which, for each use authority, “Yes” is set for items (Scan and Read) to which authority is given, and “No” is set for an item (Write) to which authority is not given.

The respective components 11 to 13 of the cloud 10 are realized by a cooperative operation of a computer that form the cloud 10 and programs that are executed by a CPU mounted on the computer. Further, the document database 14 is realized by a HDD, a RAM, or the like that is mounted on the cloud 10.

The multifunction printer 20 includes a print processing unit 21, a scan processing unit 22, and a scanned data transmission unit 23. The print processing unit 21 creates printed matter by performing the printing of the document data in response to a request from the user. The scan processing unit 22 generates scanned data by scanning a printed document (the “printed matter”) with a scanner in response to an operation instruction that is given by the user. The scanned data transmission unit 23 transmits the scanned data to the cloud 10.

The respective components 21 to 23 of the multifunction printer 20 are realized by a cooperative operation of the computer that is built in the multifunction printer 20 and programs that are executed by a CPU mounted on the computer. The functions of the multifunction printer 20 may be identical to functions in the past.

Further, as with the multifunction printer 20, the administrator terminal 30 and the user terminal 40 can also be realized to have functions identical to functions in the past. Accordingly, specific components of the administrator terminal 30 and the user terminal 40 are not shown in FIG. 2.

The information processing system 2 according to the present exemplary embodiment has the above-mentioned configuration, but is not limited to the above-mentioned configuration. The cloud 10 may be formed of a single information processing apparatus or may be formed of a plurality of information processing apparatuses. Further, the multifunction printer 20 outputting printed matter and the multifunction printer 20 scanning the printed matter may be different apparatuses. Furthermore, the administrator terminal 30 and the user terminal 40 may also be realized such that functions are distributed to a plurality of information processing apparatuses as necessary.

In addition, the programs used in the present exemplary embodiment can be provided by a communication unit, or may also be provided in a state where the programs are stored in a computer-readable recording medium, such as a USB memory. The programs provided from the communication unit or the recording medium are installed in the computer and the CPU of the computer sequentially executes the programs, so that various types of processing are realized.

Next, an operation of the present exemplary embodiment will be described.

The document data are registered and managed in the document database 14 as described above. However, in a case where the document data are stored, the document management unit 11 creates document information, which includes address information indicating a location at which the document data are stored, and associates the document information with the document data. Subsequently, the document management unit 11 sets the user-related information and the use authority information in the document information in response to, for example, a setting instruction given by the administrator. The document information may be incorporated into header information to be saved integrally with the associated document, or may be held and managed in the document database 14 separately from the document such that a correspondence relationship is ascertained.

In a case where a user logs in from the user terminal 40 or logs in to the multifunction printer 20 and requests the printing of the document data managed by the cloud 10, the print processing unit 21 of the multifunction printer 20 acquires the document data from the cloud 10 and performs the printing of the document data in response to this request. Processing of checking whether or not the user having requested the printing has authority to perform the printing of the document data in advance may be performed.

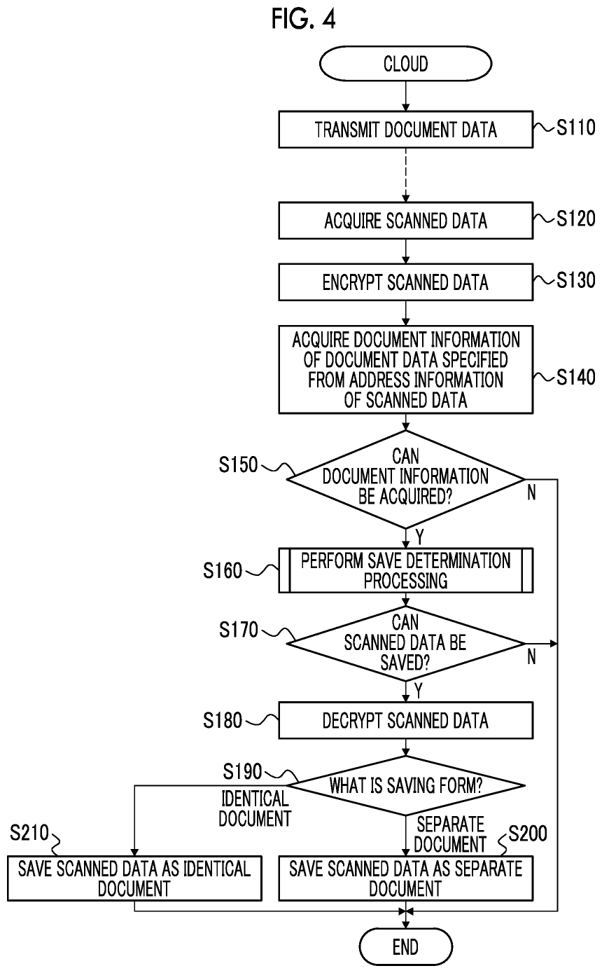

Further, the user may want to cause the multifunction printer 20 to scan printed matter, which is obtained from the printing, and may want to save scanned data, which are obtained from the scanning, in the cloud 10. Processing in the cloud 10 handling the scanned data to be saved, which are transmitted from the multifunction printer 20, will be described below with reference to a flowchart shown in FIG. 4.

Although the above-mentioned processing will be described repeatedly, the cloud 10 reads out the document data to be printed from the document database 14 and transmits the document data in response to a transmission request from the multifunction printer 20 (Step S110). In this case, the address information and the user-related information included in the document information of the document data to be printed are also transmitted.

The print processing unit 21 of the multifunction printer 20 performs the printing of the transmitted document data and outputs printed matter. In this case, the address information and the user-related information are added to the printed matter in a state where the address information and the user-related information cannot be visually recognized. A technique having existed in the past may be used as a method of adding the address information and the user-related information in a state where the address information and the user-related information cannot be visually recognized. For example, the address information and the user-related information may be embedded in the printed matter using a digital watermark technology or may be printed as two-dimensional code data.

Subsequently, in a case where a user operates the multifunction printer 20 to scan the printed matter, the scan processing unit 22 generates scanned data. Then, the scanned data transmission unit 23 transmits the scanned data to the cloud 10 together with the user ID of a user who logs in to the multifunction printer 20 for the purpose of saving.

In the cloud 10, the scanned data receiving unit 12 receives the scanned data transmitted from the multifunction printer 20 to acquire the scanned data (Step S120). Subsequently, the encryption unit 131 encrypts the acquired scanned data (Step S130). However, since the address information and the user-related information are used in processing to be described later, the encryption unit 131 needs to extract the address information and the user-related information from the scanned data and to convert the address information and the user-related information into usable information.

Subsequently, the document information acquisition unit 132 acquires document information that is added to the document data specified by the address information extracted from the scanned data (Step S140). Here, in a case where the document information cannot be acquired (N in Step S150), the processing controller 135 presumes that falsification, such as the tampering of the address information added to the printed matter, has been performed on the printed matter, and ends the processing.

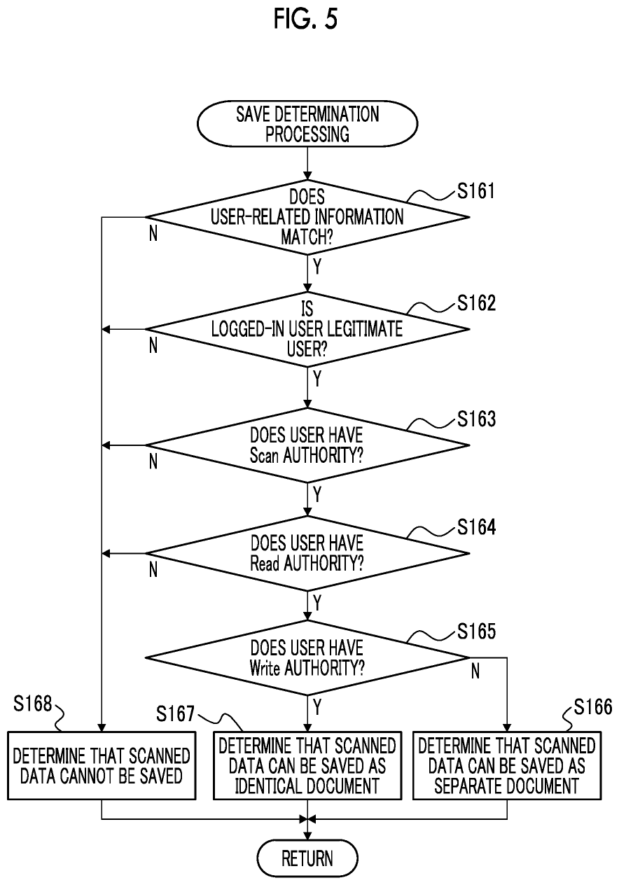

In a case where the document information can be acquired (Y in Step S150), the save determination unit 133 subsequently performs save determination processing of determining whether or not the scanned data can be saved (Step S160). The save determination processing of the present exemplary embodiment will be described below with reference to a flowchart shown in FIG. 5.

The save determination unit 133 collates the user-related information, which is extracted from the scanned data, with user-related information that is added to the document data specified from the address information extracted from the scanned data. In particular, in order to collate the use authority information in the subsequent stage, it is necessary that users match. Here, in a case where the user-related information does not match (N in Step S161), it can be assumed that one of reasons why the user-related information does not match is that a printed document having been scanned to generate scanned data is not printed matter obtained from the printing of the document data. In this case, the save determination unit 133 determines that the scanned data cannot be saved (Step S168). That is, the save determination unit 133 does not permit the scanned data to be saved.

In a case where the user-related information matches (Y in Step S161), the save determination unit 133 subsequently checks whether or not the user logging in to the multifunction printer 20, that is, the user having scanned the printed document is a legitimate user set in the user-related information. Specifically, in a case where the user ID of the user logging in to the multifunction printer 20 matches the user ID of the user set in the document data, it can be determined that the logged-in user is a legitimate user. In a case where the logged-in user is not a legitimate user (N in Step S162), the save determination unit 133 determines that the printed matter is scanned by a user other than a legitimate user and determines that the scanned data cannot be saved (Step S168).

In the following description, the term “document data” simply refers to document data of a document specified from address information extracted from the scanned data as described above.

In a case where the logged-in user is a legitimate user (Y in Step S162), the save determination unit 133 subsequently checks whether or not the user has the scanning authority of the document (“Scan” shown in FIG. 3). In a case where the user having scanned the printed document does not have the scanning authority (N in Step S163), the save determination unit 133 determines that the scanned data are actually generated by scanning but the scanning of the printed document could not be originally performed and determines that the scanned data cannot be saved (Step S168). Since the scanned data are encrypted and cannot be used, it is regarded here that the scanned data are equivalent to not being scanned.

In a case where the user has the scanning authority (Y in Step S163), the save determination unit 133 subsequently checks whether or not the user has readout authority (“Read” shown in FIG. 3). In a case where the user having scanned the printed document does not have readout authority (N in Step S164), the save determination unit 133 determines that the received scanned data are encrypted but the user does not originally have authority to encrypt the scanned data and determines that the scanned data cannot be saved (Step S168). Since the scanned data cannot be saved as a result, it is regarded that the scanned data are equivalent to being unencrypted.

In a case where the user has readout authority (Y in Step S164), the save determination unit 133 determines the saving form of the scanned data according to the setting of writing authority (“Write” shown in FIG. 3). That is, the save determination unit 133 checks whether or not the user has writing authority. However, in a case where the user does not have writing authority for the document data (N in Step S165), the save determination unit 133 determines that the document data cannot be updated with the scanned data. In this case, the save determination unit 133 determines that the document data cannot be updated with the scanned data but the scanned data can be saved as long as the scanned data are a document separate from the document data as the saving form of the scanned data (Step S166).

On the other hand, in a case where the user has writing authority for the document data (Y in Step S165), the save determination unit 133 determines that the document data can be updated with the scanned data. That is, the save determination unit 133 determines that the scanned data can be saved as a document identical to the document data as the saving form of the scanned data (Step S167). The saving of the scanned data as a document identical to the document data includes the overwriting and saving of the document data or the saving of the document data as a new version. In the following description, a case where the document data are overwritten and saved will be described by way of example.

Incidentally, an original document is basically set without writing authority so that the original document cannot be updated. It is assumed that the printed matter of the original document is written and is, for example, fraudulently tampered and then scanned. Document data, which are specified from address information extracted from scanned data of the printed matter of the original document, are certainly the document data of the original document. However, in a case where the writing authority of the original document is not checked, there is a possibility that the document data of the original document is updated with the scanned data of the written original document. Accordingly, since whether or not there is writing authority is checked before the scanned data are saved as described above in the present exemplary embodiment, it is possible to prevent the document data of the original document, which are set without writing authority, from being overwritten and updated.

Returning to FIG. 4, in a case where the save determination unit 133 determines that the scanned data cannot be saved (N in Step S170), the processing controller 135 ends the processing without saving the scanned data.

On the other hand, in a case where the save determination unit 133 determines that the scanned data can be saved (Y in Step S170), the encryption unit 131 decrypts the scanned data (Step S180). Subsequently, in a case where the save determination unit 133 determines that the scanned data can be saved as long as the scanned data are a document separate from the document data (“separate document” in Step S190), the scanned data saving unit 134 saves the scanned data as a document separate from the document data (Step S200). For this reason, the scanned data saving unit 134 acquires address information indicating a location at which the scanned data are stored, creates document information including the address information, and associates the document information with the scanned data. In this way, the scanned data can be handled as document data separate from the document data.

On the other hand, in a case where the save determination unit 133 determines that the scanned data can be saved as a document identical to the document data (“identical document” in Step S190), the scanned data saving unit 134 overwrites and saves the document data with the scanned data (Step S210). Alternatively, the scanned data saving unit 134 may save the scanned data as the latest version of the document data. In a case where the scanned data saving unit 134 saves the scanned data as the latest version, a document is created as a separate file even though the document is a substantially identical document. Accordingly, the scanned data saving unit 134 acquires address information and associates the address information with the scanned data. Further, the scanned data saving unit 134 or the document management unit 11 takes over document information other than the address information from the document data and sets the document information. Alternatively, the administrator may be made to set the document information separately.

As described above, a user having writing authority can overwrite and update the document as intended. On the other hand, a user who does not have writing authority but wants to save scanned data can save the scanned data as a document that is separate from the document data without being discarded.

The scanned data are automatically saved in the present exemplary embodiment, but a user may check a saving form or whether or not to save the scanned data before saving the scanned data. Further, although not included in the processing since not being the characteristics of the present exemplary embodiment, processing of determining identity between the scanned data and the document data may be included.

### Second Exemplary Embodiment

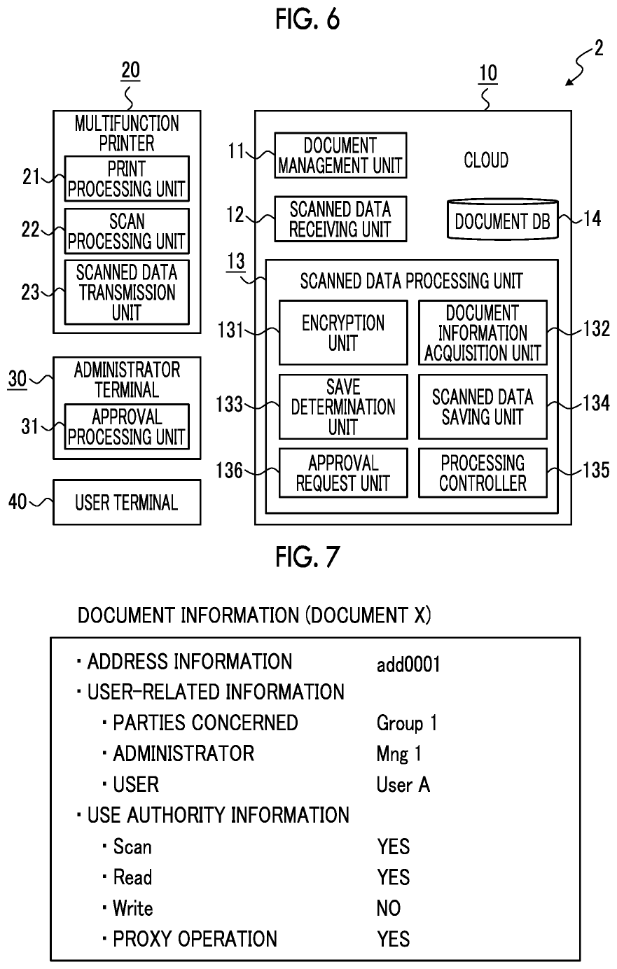

FIG. 6 is a block diagram showing an information processing system 2 according to the present exemplary embodiment. The information processing system 2 according to the present exemplary embodiment has a configuration in which an approval request unit 136 and an approval processing unit 31 are added to the configuration of the first exemplary embodiment. Further, FIG. 7 is a diagram showing an example of a data configuration of document information that is added to document data handled in the present exemplary embodiment. As shown in FIG. 7, the document information includes address information, user-related information, and use authority information as in the first exemplary embodiment, but the present exemplary embodiment is different from the first exemplary embodiment in that proxy operation authority is further included in the use authority information.

“Proxy operation authority” is authority showing whether or not a user can cause a logged-in user to perform a proxy operation for saving scanned data in a case where a person different from the user included in the user-related information of the document information scans printed matter, that is, in a case where the user does not match the user logging in to the multifunction printer 20.

In the first exemplary embodiment, in Step S162 shown in FIG. 5, the save determination unit 133 determines that the scanned data cannot be saved in a case where the logged-in user is not a legitimate user set in the user-related information. However, if the scanned data of the printed document cannot be saved unconditionally in a case where a legitimate user cannot scan a printed document by oneself due to a certain reason, a case where the legitimate user is inconvenient is also conceivable.

Accordingly, in the present exemplary embodiment, proxy operation authority is provided as one piece of use authority information, and a user can cause a logged-in user to perform a proxy operation for saving the scanned data in a case where “Yes” indicating that the user has authority is set for the proxy operation authority as shown in FIG. 7.

Although details will be described later, the approval request unit 136 included in the scanned data processing unit 13 of the cloud 10 makes an approval request to an administrator to obtain approval to cause the logged-in user to perform the proxy operation. Further, the approval processing unit 31 included in the administrator terminal 30 performs approval processing that causes the administrator to determine whether or not the proxy operation can be performed in response to the approval request made from the cloud 10 and returns a determination result. The approval request unit 136 is realized by a cooperative operation of a computer that form the cloud 10 and a program that is executed by a CPU mounted on the computer. Further, the approval processing unit 31 is realized by a cooperative operation of a computer that form the administrator terminal 30 and a program that is executed by a CPU mounted on the computer.

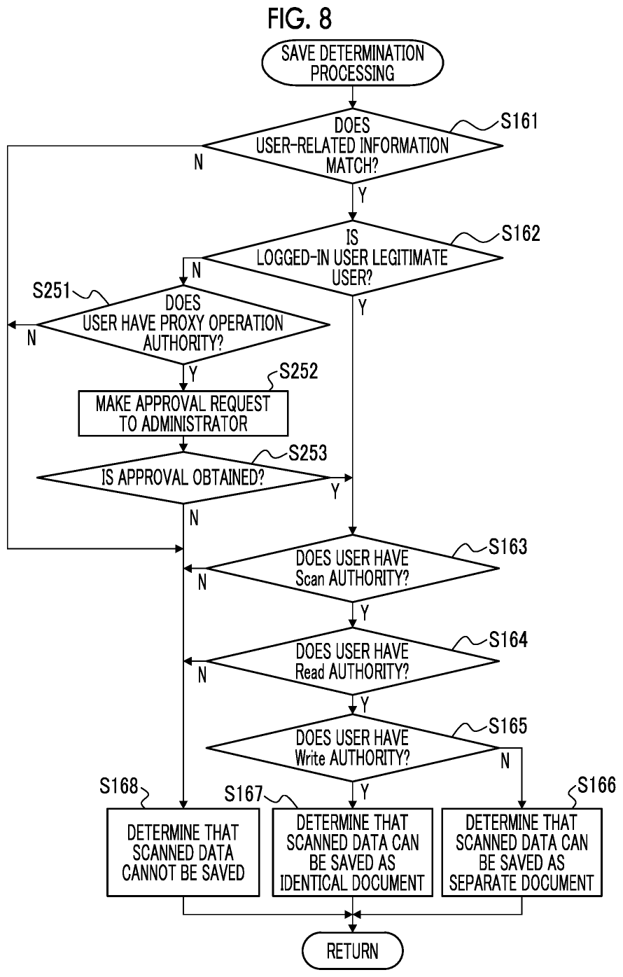

Next, processing in the cloud 10 handling the scanned data to be saved, which are transmitted from the multifunction printer 20, will be described in the present exemplary embodiment. The processing of the present exemplary embodiment may be identical to the processing of the first exemplary embodiment described with reference to the flowchart shown in FIG. 4. Save determination processing in Step S160 of the present exemplary embodiment is separate from the save determination processing of the first exemplary embodiment. The save determination processing of the present exemplary embodiment will be described below with reference to a flowchart shown in FIG. 8. Processing steps identical to the processing steps of the first exemplary embodiment shown in FIG. 5 will be denoted by reference numerals identical to the reference numerals shown in FIG. 5, and the description thereof will be omitted as appropriate.

As shown in FIG. 8, in the save determination processing of the present exemplary embodiment, Steps S251 to S253 are added to the save determination processing of the first exemplary embodiment. That is, in a case where the logged-in user is not a legitimate user (N in Step S162), the save determination unit 133 immediately determines that the scanned data cannot be saved in the first exemplary embodiment, but checks whether or not there is proxy operation authority before determining that the scanned data cannot be saved in the present exemplary embodiment. In a case where a legitimate user does not have proxy operation authority (N in Step S251), the save determination unit 133 determines that the scanned data cannot be saved as a result as in the first exemplary embodiment (Step S168).

On the other hand, in a case where a legitimate user has proxy operation authority (Y in Step S251), the approval request unit 136 makes an approval request to an administrator (Step S252). As described above, in a case where “Yes” is set for proxy operation authority with reference to the use authority information of a user set in the document data even though the user ID of an operator who operates the multifunction printer 20 generating the scanned data, that is, a user who logs in to the multifunction printer 20 does not match the user ID of the user set in the document data, the approval request unit 136 of the present exemplary embodiment makes an approval request to an administrator of the document to cause the logged-in user to perform a proxy operation. Since the administrator uses the administrator terminal 30, the approval request unit 136 acquires a mail address serving as a contact address of the administrator with reference to administrator information (not shown) and transmits a mail in a case where the approval request unit 136 makes an approval request using, for example, an e-mail. The approval request unit 136 requests an approval of a proxy operation in this way. In order to obtain approval from the administrator, an approval request is made including at least information that can specify a legitimate user requesting the proxy operation and a logged-in user performing the proxy operation in addition to a purpose of obtaining the approval of the proxy operation.

In a case where the approval request is sent from the cloud 10, the approval processing unit 31 displays the contents of the e-mail on a display or the like in response to an administrator's operation. Then, the approval processing unit 31 returns a determination result of whether or not the administrator approves.

The cloud 10 receives the response of the approval request from the administrator terminal 30 in this way. In a case where the approval of the proxy operation is obtained from the administrator (Y in Step S253), the save determination unit 133 causes the processing to proceed to Step S253. Since processing subsequent to Step S253 may be identical to the processing of the first exemplary embodiment, the description thereof will be omitted. On the other hand, in a case where the approval of the proxy operation is not obtained from the administrator (N in Step S253), the save determination unit 133 determines that the scanned data cannot be saved as a result as in the first exemplary embodiment (Step S168).

According to the present exemplary embodiment, proxy operation authority is included in the use authority information and the proxy operation authority is referred in a case where whether or not the scanned data can be saved is determined. Accordingly, it is possible to allow another user, that is, a user who logs in to the multifunction printer 20 in the above description to save the scanned data instead. Therefore, even in a situation where a user cannot perform an operation for saving the scanned data by oneself, the user can save the scanned data as intended. Even in a situation where a user can perform an operation for saving the scanned data as apparent from the fact that determining whether or not the user can perform an operation for saving the scanned data by oneself is not included in the save determination processing, it is possible to allow another user to save the scanned data instead.

In the embodiments above, the term “processor” refers to hardware in a broad sense. Examples of the processor include general processors (e.g., CPU: Central Processing Unit) and dedicated processors (e.g., GPU: Graphics Processing Unit, ASIC: Application Specific Integrated Circuit, FPGA: Field Programmable Gate Array, and programmable logic device).

In the embodiments above, the term “processor” is broad enough to encompass one processor or plural processors in collaboration which are located physically apart from each other but may work cooperatively. The order of operations of the processor is not limited to one described in the embodiments above, and may be changed.

### Supplementary Note

(((1)))
An information processing system comprising:
a processor configured to:
   extract document-specifying information and user identification information from scanned data of a printed document obtained from printing of document data of a document, the document-specifying information and the user identification information being added to the printed document, the document-specifying information specifying the document, and the user identification information identifying a user allowed to use the document;
   extract use authority information about the document that is set in the document data of the document specified by the extracted document-specifying information and is given to the user identification information identifying the user allowed to use the document and the user; and
   determine handling of the scanned data depending on the extracted use authority information.
(((2)))
The information processing system according to (((1))), wherein the processor is configured to:
in a case where user identification information of an operator causing a scanner to scan the printed document to generate the scanned data matches the user identification information set in the document data of the document specified by the document-specifying information,
determine a saving form of the scanned data depending on writing authority of the operator set in the use authority information.
(((3)))
The information processing system according to (((2))), wherein the processor is configured to:
save the scanned data as a document separate from the document in a case where the operator does not have writing authority.
(((4)))
The information processing system according to (((2))) or (((3))), wherein the processor is configured to:
update the document data with the scanned data in a case where the operator has writing authority.
(((5)))
The information processing system according to (((1))), wherein the processor is configured to:
in a case where user identification information of an operator generating the scanned data does not match the user identification information set in the document data of the document specified by the document-specifying information,
not permit the scanned data to be saved.
(((6)))
The information processing system according to (((5))), wherein the processor is configured to:
make an approval request to an administrator of the document to cause the operator to perform a proxy operation in a case where proxy operation authority is set for the user allowed to use the document with reference to the use authority information even though the user identification information of the operator does not match the user identification information set in the document data of the document specified by the document-specifying information, and
allow the scanned data to be saved in a case where approval is obtained from the administrator.
(((7)))
A program causing a computer to realize:
a function of extracting document-specifying information and user identification information from scanned data of a printed document obtained from printing of document data of a document, the document-specifying information and the user identification information being added to the printed document, the document-specifying information specifying the document, and the user identification information identifying a user allowed to use the document;
a function of extracting use authority information about the document that is set in the document data of the document specified by the extracted document-specifying information and is given to the user identification information identifying the user allowed to use the document and the user; and
a function of determining handling of the scanned data depending on the extracted use authority information.
The foregoing description of the exemplary embodiments of the present invention has been provided for the purposes of illustration and description. It is not intended to be exhaustive or to limit the invention to the precise forms disclosed. Obviously, many modifications and variations will be apparent to practitioners skilled in the art. The embodiments were chosen and described in order to best explain the principles of the invention and its practical applications, thereby enabling others skilled in the art to understand the invention for various embodiments and with the various modifications as are suited to the particular use contemplated. It is intended that the scope of the invention be defined by the following claims and their equivalents.

What is claimed is:

1. An information processing system comprising:
a processor configured to:
extract document-specifying information and user identification information from scanned data of a printed document obtained from printing of document data of a document, the document-specifying information and the user identification information being added to the printed document, the document-specifying information specifying the document, and the user identification information identifying a user allowed to use the document;
extract use authority information about the document that is set in the document data of the document specified by the extracted document-specifying information and is given to the user identification information identifying the user allowed to use the document and the user; and
determine handling of the scanned data depending on the extracted use authority information.

2. The information processing system according to claim 1, wherein the processor is configured to:
in a case where user identification information of an operator causing a scanner to scan the printed document to generate the scanned data matches the user identification information set in the document data of the document specified by the document-specifying information,
determine a saving form of the scanned data depending on writing authority of the operator set in the use authority information.

3. The information processing system according to claim 2, wherein the processor is configured to:
save the scanned data as a document separate from the document in a case where the operator does not have writing authority.

4. The information processing system according to claim 2, wherein the processor is configured to:
update the document data with the scanned data in a case where the operator has writing authority.

5. The information processing system according to claim 1, wherein the processor is configured to:
in a case where user identification information of an operator generating the scanned data does not match the user identification information set in the document data of the document specified by the document-specifying information,
not permit the scanned data to be saved.

6. The information processing system according to claim 5, wherein the processor is configured to:
make an approval request to an administrator of the document to cause the operator to perform a proxy operation in a case where proxy operation authority is set for the user allowed to use the document with reference to the use authority information even though the user identification information of the operator does not match the user identification information set in the document data of the document specified by the document-specifying information, and
allow the scanned data to be saved in a case where approval is obtained from the administrator.

7. A non-transitory computer readable medium storing a program causing a computer to realize:
a function of extracting document-specifying information and user identification information from scanned data of a printed document obtained from printing of document data of a document, the document-specifying information and the user identification information being added to the printed document, the document-specifying information specifying the document, and the user identification information identifying a user allowed to use the document;
a function of extracting use authority information about the document that is set in the document data of the document specified by the extracted document-specifying information and is given to the user identification information identifying the user allowed to use the document and the user; and
a function of determining handling of the scanned data depending on the extracted use authority information.

8. An information processing method comprising:
extracting document-specifying information and user identification information from scanned data of a printed document obtained from printing of document data of a document, the document-specifying information and the user identification information being added to the printed document, the document-specifying information specifying the document, and the user identification information identifying a user allowed to use the document;
extracting use authority information about the document that is set in the document data of the document specified by the extracted document-specifying information and is given to the user identification information identifying the user allowed to use the document and the user; and
determining handling of the scanned data depending on the extracted use authority information.
